(19) United States
(12) Patent Application Publication
(10) Pub. No.: US 2003/0033453 A1
(43) Pub. Date: Feb. 13, 2003

(54) Method and device for message communication for programmable controller

(76) Inventor: Hisashi Nakata, Kitakyushu-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/204,437

(22) PCT Filed: Feb. 22, 2001
(86) PCT No.: PCT/JP01/01327

(30) Foreign Application Priority Data
Mar. 1, 2000 (JP) 2000-55194

(51) Int. Cl. G06F 3/00

(52) U.S. Cl. 710/14; 710/1

(57) ABSTRACT

Prior art (1) involves a problem that a useless processing is always done even if the user does not use message communication; and prior art (2) involves a problem that the user has to describe a function in a program, and therefore this may be more trouble than prior art (1) and the technical level of the user is required to be high enough to describe the function correctly. A message communication method and device for a programmable controller according to the invention having both advantages of prior arts (1) and (2) and comprising a CPU module and a communication module is characterized in that the transmission parameter of the communication module is defined (Q2), and the user selects (SW) one of the settings: one is such that message communication (S2) is automatically done, and the other is such that the user can describe a function (S3) for message communication.

### TECHNICAL FIELD

The present invention relates to a programmable controller (hereinafter, referred to as a PLC) comprising a CPU module and a communication module and a method and device for message communication using the communication module.

### BACKGROUND ART

A conventional method for message communication for a PLC comprising a CPU module and a communication module is described with reference to the drawing. FIG. 2 is a construction drawing of a PLC for message communication. In FIG. 2, CPU module 1 executes a user program S1. Communication module 2 connects a cable A2 to external equipment connection port (communication port) P2. Bus A1 connects modules, and the CPU module 1 and the communication module 2 exchange data with each other via the bus A1. Communication equipment 3 communicates with the PLC by connecting the cable A2.

The communication equipment 3 transmits a command conforming to a purpose, and the CPU module 1 returns a response to the command via the communication module 2. Or, the CPU module 1 transmits a command conforming to a purpose via the communication module, and the communication equipment 3 returns a response to the command. Generally, the side for issuing a command is called a master, and the side for returning a response to the command is called a slave. Herein, a case where communication equipment serves as a master is considered.

FIG. 3 is a drawing for explaining a conventional method for executing message communication. The following two methods exist for a user to make the CPU module 1 return a response to a received command from the communication equipment 3. One is a method in which message communication processing S2 is automatically executed before or after executing a user program S1, and this method is defined as a prior art (1). Another is a method in which a user writes a function S3 for message communication processing into a user program S1, and this method is defined as a prior art (2).

The prior art (1) has an advantage whereby there is nothing for a user to do. However, message communication processing is always executed even when a user does not use message communication, and this is wasteful. On the other hand, in the prior art (2), there is no wastefulness since processing is executed only when a user desires to use message communication. However, this prior art involves a problem that a user is required to write a function into the program, and this takes a great deal of time in comparison with the prior art (1), and the technical level of the user is required to be sufficiently proficient to write the function correctly.

An object of the invention is, therefore, to provide a method and a device for message communication having the advantages of both prior arts (1) and (2) by employing selection between automatic execution and function description by a user for a message communication method.

### DISCLOSURE OF THE INVENTION

In order to solve the abovementioned problems, the present invention is characterized in that, in a programmable controller comprising a CPU module and a communication module, at the same time of definition of transmission parameters of said communication module, it is selected whether message communication is automatically executed or a user can write a function for message communication.

### BRIEF DESCRIPTION OF THE DRAWINGS

FIG. 1 is a drawing showing a method for executing message communication;

FIG. 2 is a construction drawing of a PLC for message communication; and

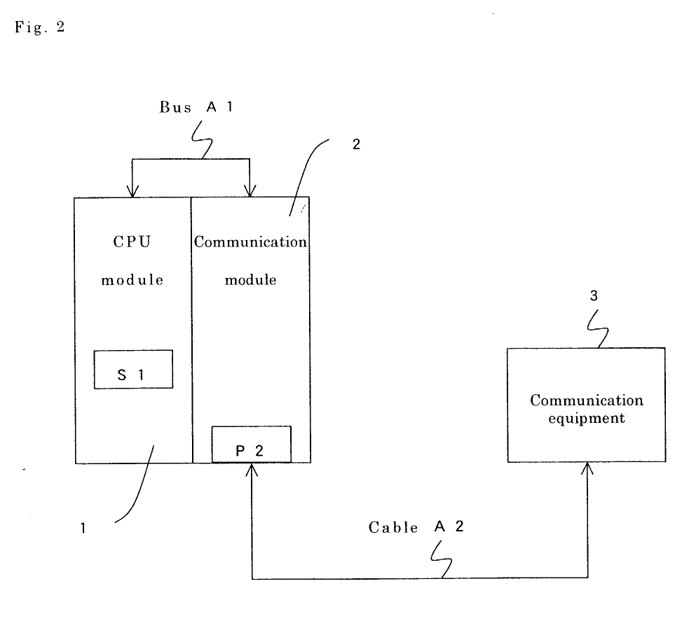

FIG. 3 is a drawing for explaining a conventional method for executing message communication.

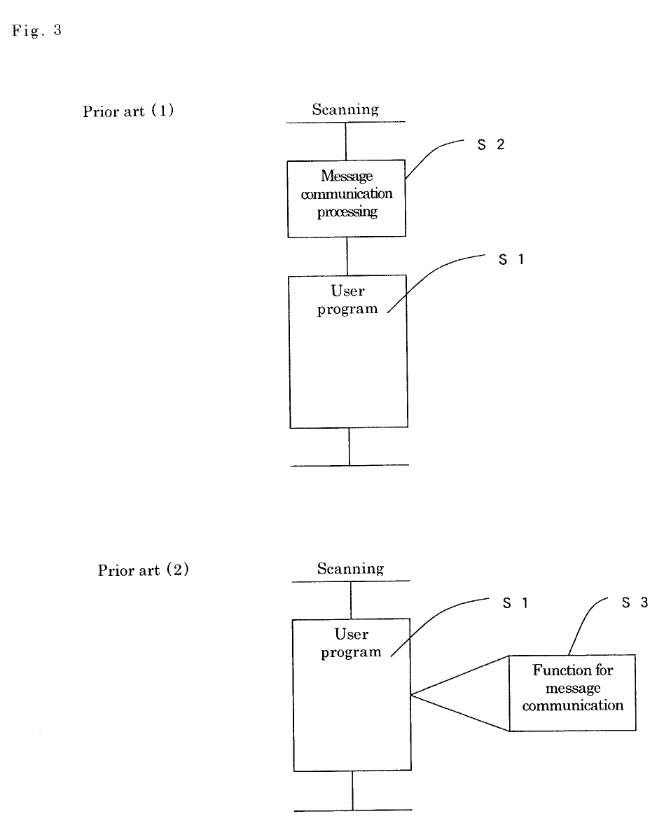

### BEST MODE FOR CARRYING OUT THE INVENTION

Hereinafter, an embodiment of the invention is described with reference to the accompanying drawings.

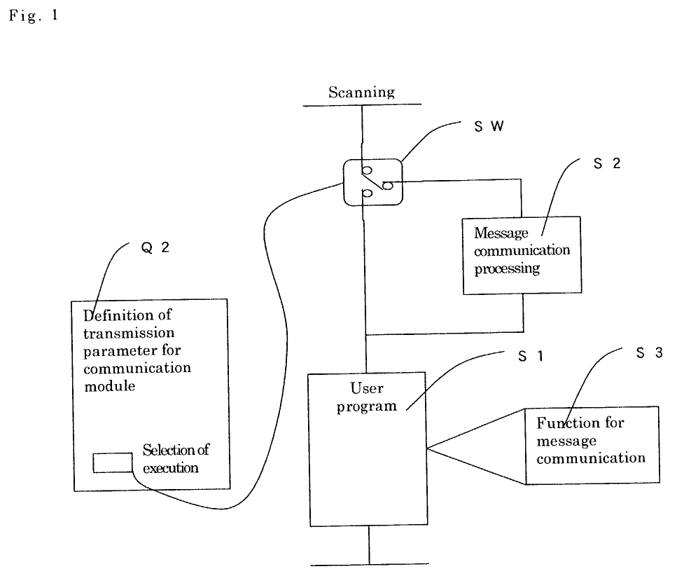

FIG. 1 is a drawing showing a method for executing message communication. In FIG. 1, user program S1 is started and executed in a predetermined cycle.

A user writes a program into the user program S1 so that the PLC executes a target operation. Message communication processing S2 has a function for automatically executing message communication processing without a clear description made by the user.

It can be selected whether or not the message communication processing S2 is executed. Generally, the communication module is structured so that its transmission parameters (master/slave selection, address, protocol, and transmission rate, etc.) can be set by hardware or software.

The user selects by a switch SW (software or hardware) whether or not the message communication processing S2 is automatically executed when he/she sets transmission parameter definition Q2 of the communication module. The function S3 is a function for message communication. It is also possible for the user to strictly specify communication executing conditions and execution timing in detail by writing the function S3 for message communication into the user program S1.

As described above, according to the invention, in a case where message communication is made by a PLC comprising a CPU module and a communication module, by making a selection as to the possibility of message communication being automatically executed possible, a message communication method suitable to the technical level of a user is realized.

### INDUSTRIAL APPLICABILITY

According to the invention, the range of available user applications in message communication is widened, and it becomes possible to provide a programmable controller which can satisfy both requirements of simple operability and customized use.

What is claimed is:

1. A method for message communication for a programmable controller comprising a CPU module and a communication module, wherein
it is selected whether message communication is automatically carried out or a user can write a function for message communication at the same time of definition of transmission parameters of said communication module.

2. A message communication device for a programmable controller comprising a CPU module and a communication module, comprising:
defining means for transmission parameters of said communication module; and
switch means for selecting whether message communication is automatically executed or a user can write a function for message communication.
